(19) United States
(12) Patent Application Publication
(10) Pub. No.: US 2023/0167214 A1
(43) Pub. Date: Jun. 1, 2023

(54) RESIN COMPOSITION FOR SINTERING, INORGANIC FINE PARTICLE DISPERSED SLURRY COMPOSITION, AND INORGANIC FINE PARTICLE DISPERSED SHEET

(71) Applicant: SEKISUI CHEMICAL CO., LTD., Osaka (JP)

(72) Inventors: Kenji YAMAUCHI, Osaka (JP); Takeshi WAKIYA, Osaka (JP); Tatsuya MATSUKUBO, Yamaguchi (JP); Kanako TAMAGAWA, Shiga (JP); Jo OTSUKA, Yamaguchi (JP); Yumi KANEKO, Yamaguchi (JP)

(73) Assignee: SEKISUI CHEMICAL CO., LTD., Osaka (JP)

(21) Appl. No.: 17/784,217

(22) PCT Filed: Dec. 10, 2020
(86) PCT No.: PCT/JP2020/046012

§ 371 Date: Jun. 10, 2022

(30) Foreign Application Priority Data
Dec. 17, 2019 (JP) 2019-227353

(51) Int. Cl. C08F 220/18; C08F 2/38

(52) U.S. Cl. CPC C08F 220/1804; C08F 2/38

(57) ABSTRACT

The present invention provides a resin composition for sintering, an inorganic fine particle-dispersed slurry composition containing the resin composition for sintering, and an inorganic fine particle-dispersed sheet formed using the resin composition for sintering or inorganic fine particle-dispersed slurry composition. The present invention relates to a resin composition for sintering, containing a binder resin, the binder resin including a (meth)acrylic resin (A), the (meth)acrylic resin (A) having at least one selected from the group consisting of a sulfone group, an alkyl sulfonyl group, an aromatic sulfonyl group, a sulfine group, an imidazoline group, a carboxy group, an amide group, an amino group, and a hydroxy group at at least one molecular end of the main chain and having a weight average molecular weight (Mw) of 1,000,000 or more, an amount of a water-soluble surfactant in the resin composition for sintering being 0 parts by weight or more and 0.02 parts by weight or less per 100 parts by weight of the binder resin.

### TECHNICAL FIELD

The present invention relates to a resin composition for sintering, an inorganic fine particle-dispersed slurry composition containing the resin composition for sintering, and an inorganic fine particle-dispersed sheet formed using the resin composition for sintering or the inorganic fine particle-dispersed slurry composition.

### BACKGROUND ART

Compositions containing inorganic fine particles (e.g., ceramic powder or glass particles) dispersed in a binder resin have been used in production of laminated electronic components such as ceramic capacitors.

Such ceramic capacitors are commonly produced by the following method. First, additives such as a plasticizer and a dispersant are added to a solution of a binder resin in an organic solvent. Ceramic raw material powder is then added, and the materials are uniformly mixed with a ball mill or the like to give an inorganic fine particle-dispersed composition.

The obtained inorganic fine particle-dispersed composition is casted on a surface of a support such as a release-treated polyethylene terephthalate film or a SUS plate using a doctor blade, a reverse roll coater, or the like. The organic solvent and other volatile components are evaporated, and then the composition is separated from the support to give a ceramic green sheet.

Next, a conductive paste to form an internal electrode is applied to the obtained ceramic green sheet by screen printing or the like. Sheets obtained in this manner are stacked and pressure-bonded with heat to prepare a laminate. The obtained laminate is heated to perform what is called “debinding”, a treatment to remove components such as the binder resin by pyrolysis. The laminate is then fired to give a ceramic fired body including internal electrodes. External electrodes are then applied to the end surfaces of the ceramic fired body, followed by firing. A multilayer ceramic capacitor is thus completed.

For example, Patent Literature 1 discloses a binder composition for ceramic molding, wherein the binder composition has a molecular weight of 160,000 to 180,000 and contains 60 to 99% by weight of isobutyl methacrylate, 1 to 39% by weight of 2-ethylhexyl methacrylate, and 1 to 15% by weight of a methacrylate having a hydroxy group at the β- or ω- position.

Patent Literature 2 discloses production of an acrylic resin for a firing paste which can exhibit a high viscosity enough to satisfy screen printability, in which the acrylic resin is produced by emulsion polymerization of methyl methacrylate, isobutyl methacrylate, and crosslinkable bifunctional methacrylate, starting from seed particles. Patent Literature 2 also discloses a firing paste composition containing the acrylic resin.

Patent Literature 3 discloses an aqueous binder resin composition for firing containing a polymerization reaction product (E) produced by emulsion polymerization of an acrylic monomer (D1) in the presence of a polyethylene oxide (A) and a polyoxyalkylene ether-type surfactant (b).

### CITATION LIST

### Patent Literature

Patent Literature 1: JP H10-167836 A Patent Literature 2: JP 5594508 B Patent Literature 3: JP 2018-2991 A

### SUMMARY OF INVENTION

### Technical Problem

Inorganic fine particle-dispersed slurry compositions for producing ceramic green sheets typically contain polyvinyl alcohol resins or polyvinyl acetal resins as binders. Having a high decomposition temperature, these resins disadvantageously cannot be used in applications in which firing at low temperature is desired, such as use in combination with easily oxidizable metals (e.g., copper), low-melting-point glass, or the like.

Inorganic fine particle-dispersed sheets are demanded to be debinded without containing residual carbon even at the center part thereof and to have high yield stress and high elongation at break before firing.

In the case where a typical binder such as a polyvinyl alcohol resin, polyvinyl butyral resin, or cellulosic resin is used, normally, oxygen is needed to debind the binder resin. The center part of the molded body where oxygen is not likely to reach disadvanrageously contain a large amount of residual carbon, causing cracking or blisters during firing to lower the yield.

In such a situation, use of a (meth)acrylic resin which can be fired at low temperature and leaves a smaller amount of residual carbon components after firing has been studied.

The binder resin in Patent Literature 1 is produced by solution polymerization and has a molecular weight of less than 200,000. Such a binder resin is brittle as a whole to be disadvantageously incapable of providing sufficient sheet strength.

The acrylic resin for a firing paste in Patent Literature 2 is prepared by emulsion polymerization in which a poorly sinterable dispersant is added, and therefore tends to generate soot upon firing. When the acrylic resin thus obtained is dissolved in an organic solvent to prepare an inorganic fine particle-dispersed slurry composition, the emulsifier may remain as a foreign substance to cloud the slurry to white. Moreover, the sheet produced may not have sufficient sheet strength.

According to Patent Literature 3, a favorably sinterable ether material is used as an emulsifier to improve decomposability of the resulting polymerization reaction product. Since the polymerization reaction product is obtained by emulsion polymerization, the emulsifier may remain therein as a foreign substance. Also, the resulting polymerization reaction product has a low molecular weight to fail to provide sufficient sheet strength.

The present invention aims to provide a resin composition for sintering which has excellent decomposability at low temperature, can provide a molded article having high strength, and enables an increase in the number of layers and thinning so as to enable production of a ceramic laminate having excellent properties. The present invention also aims to provide an inorganic fine particle-dispersed slurry composition containing the resin composition for sintering, and an inorganic fine particle-dispersed sheet formed using the resin composition for sintering or the inorganic fine particle-dispersed slurry composition.

### Solution to Problem

The present invention relates to a resin composition for sintering, containing a binder resin, the binder resin including a (meth)acrylic resin (A), the (meth)acrylic resin (A) having at least one selected from the group consisting of a sulfone group, an alkyl sulfonyl group, an aromatic sulfonyl group, a sulfine group, an imidazoline group, a carboxy group, an amide group, an amino group, and a hydroxy group at at least one molecular end of the main chain and having a weight average molecular weight (Mw) of 1,000,000 or more, an amount of a water-soluble surfactant in the resin composition for sintering being 0 parts by weight or more and 0.02 parts by weight or less per 100 parts by weight of the binder resin.

The present invention is specifically described in the following.

The present inventors found out that siterability and sheet strength can be both achieved when a resin composition for sintering used contains a (meth)acrylic resin having a specific substituent at a molecular end and having a weight average molecular weight of 1,000,000 or more, and the amount of a water-soluble surfactant in the resin composition is within a specific range. They also found out that when such a resin composition for sintering is used in production of an inorganic fine particle-dispersed sheet, thin films are easily molded and debinding is favorably carried out, so that a thin-film molded body is produced at a high yield. Thus, the present invention was completed.

The resin composition for sintering of the present invention contains a binder resin.

The binder resin contains a (meth)acrylic resin (A).

The (meth)acrylic resin (A) has at least one selected from the group consisting of a sulfone group, an alkyl sulfonyl group, an aromatic sulfonyl group, a sulfine group, an imidazoline group, a carboxy group, an amide group, an amino group, and a hydroxy group at at least one molecular end of the main chain and has a weight average molecular weight (Mw) of 1,000,000 or more.

The (meth)acrylic resin (A) has at least one selected from the group consisting of a sulfone group, an alkyl sulfonyl group, an aromatic sulfonyl group, a sulfine group, an imidazoline group, a carboxy group, an amide group, an amino group, and a hydroxy group at at least one molecular end of the main chain.

A (meth)acrylic resin containing the specific substituent enables achievement of both sinterability and sheet strength.

The (meth)acrylic resin (A) has any of the functional groups at at least one molecular end of the main chain. In the case where the functional group is a carboxy group, the (meth)acrylic resin (A) may have a carboxyalkylamino group (e.g., carboxyethylamino group) or a carboxyalkylamidine group (e.g., carboxyethylamidine group), as well as a carboxy group, at a molecular end.

In the case where the functional group is a hydroxy group, the (meth)acrylic resin (A) may have a hydroxyalkylamino group (e.g., hydroxyethylamino group) or a hydroxyalkylamide group (e.g., hydroxyethylamide group), as well as a hydroxy group, at a molecular end.

Moreover, the sulfone group may be a salt or an ester. Examples of the salt include ammonium salt, sodium salt, and potassium salt. Examples of the ester include esters containing C1-C12 aliphatic groups or C6-C12 aromatic groups. More preferred are alkyl esters.

Examples of the alkyl sulfonyl group include sulfonyl groups containing C1-C12 alkyl groups. Specific examples include a methyl sulfonyl group, an ethyl sulfonyl group, and a propyl sulfonyl group.

Examples of the aromatic sulfonyl group include sulfonyl groups containing aromatic groups having a carbon number of 12 or less. Specific examples include a phenyl sulfonyl group.

The sulfine group may be a salt or an ester.

Examples of the salt include ammonium salt, sodium salt, and potassium salt. Examples of the ester include esters containing C1-C12 aliphatic groups or C6-C12 aromatic groups. More preferred are alkyl esters.

The amino group may be a C1-C10 (preferably C1-C5, more preferably C1-C3) monoamino, diamino, or triamino group.

In particular, the (meth)acrylic resin (A) preferably has a sulfone group at a molecular end.

In a preferred embodiment of the present invention, the specific substituent at at least one molecular end of the main chain of the (meth)acrylic resin (A) is preferably derived from a polymerization initiator.

The (meth)acrylic resin (A) preferably contains a segment derived from isobutyl methacrylate.

(Meth)acrylic resins are depolymerized by heat to be decomposed to monomers and therefore are not likely to generate residual carbon. Containing a segment derived from isobutyl methacrylate, the (meth)acrylic resin (A) is also excellent in decomposability at low temperature.

The lower limit of the amount of the segment derived from isobutyl methacrylate in the (meth)acrylic resin (A) is preferably 40% by weight and the upper limit thereof is preferably 70% by weight.

When the amount of the segment derived from isobutyl methacrylate is within the above preferable range, decomposability at low temperature is further excellent.

The lower limit of the amount of the segment derived from isobutyl methacrylate is more preferably 50% by weight and the upper limit thereof is more preferably 60% by weight.

From the standpoint of decomposability at low temperature, high strength, and facilitation of increasing the number of layers and thinning, the (meth)acrylic resin (A) preferably further contains a segment derived from at least one selected from the group consisting of methyl methacrylate, n-butyl methacrylate, and ethyl methacrylate.

In order to keep high yield stress, the (meth)acrylic resin preferably has a glass transition temperature of 40° C. or higher. Copolymerization with methyl methacrylate or ethyl methacrylate that has a higher glass transition temperature as a homopolymer than isobutyl methacrylate increases the yield stress of the resulting sheet.

Addition of a plasticizer is desirable in order to improve brittleness of the inorganic fine particle-dispersed sheet. However, isobutyl methacrylate, methyl methacrylate, and ethyl methacrylate each contain an ester substituent which is short to have poor plasticizer retention, and therefore tend to cause bleeding of plasticizers upon processing into an inorganic fine particle-dispersed sheet. Accordingly, in order to enhance plasticizer retention while maintaining a high glass transition temperature, copolymerization with n-butyl methacrylate is desired.

In the (meth)acrylic resin (A), the lower limit of the total amount of the segment derived from methyl methacrylate, the segment derived from n-butyl methacrylate, and the segment derived from ethyl methacrylate is preferably 20% by weight, more preferably 30% by weight, still more preferably 40% by weight and the upper limit thereof is preferably 60% by weight, more preferably 50% by weight.

When the total amount is within the above range, decomposability at low temperature can be exhibited.

In the (meth)acrylic resin (A), the lower limit of the total amount of the segment derived from isobutyl methacrylate, the segment derived from methyl methacrylate, the segment derived from n-butyl methacrylate, and the segment derived from ethyl methacrylate is preferably 50% by weight and the upper limit thereof is preferably 100% by weight.

When the total amount is 50% by weight or more, the yield stress can be increased, so that an inorganic fine particle-dispersed sheet having resilience can be obtained. When the total amount is 100% by weight or less, both the decomposability at low temperature and the sheet strength can be achieved.

The lower limit of the total amount is more preferably 55% by weight, still more preferably 60% by weight, still further more preferably 65% by weight, particularly preferably 70% by weight, particularly more preferably 80% by weight, even more preferably 85% by weight, significantly preferably 90% by weight. The upper limit thereof is more preferably 97% by weight, still more preferably 95% by weight.

The (meth)acrylic resin (A) may contain a segment derived from a (meth)acrylate containing an ester substituent having a carbon number of 8 or more. The expression “containing an ester substituent having a carbon number of 8 or more” means that the total number of carbon atoms other than the carbon atoms constituting the (meth)acryloyl group in the (meth)acrylate is 8 or more.

The presence of the segment derived from a (meth)acrylate containing an ester substituent having a carbon number of 8 or more can sufficiently lower the decomposition ending temperature of the (meth)acrylic resin, and allows the resulting inorganic fine particle-dispersed sheet to be tough.

In the (meth)acrylate containing an ester substituent having a carbon number of 8 or more, the ester substituent preferably has a branched chain structure.

The upper limit of the carbon number of the ester substituent is preferably 30, more preferably 20, still more preferably 10.

Examples of the (meth)acrylate containing a linear or branched alkyl group include 2-ethylhexyl (meth)acrylate, n-nonyl (meth)acrylate, isononyl (meth)acrylate, n-decyl (meth)acrylate, isodecyl (meth)acrylate, n-lauryl (meth)acrylate, isolauryl (meth)acrylate, n-stearyl (meth)acrylate, and isostearyl (meth)acrylate.

Preferred among them are (meth)acrylates containing a branched alkyl group having a carbon number of 8 or more. More preferred are 2-ethylhexyl (meth)acrylate, isononyl (meth)acrylate, isodecyl (meth)acrylate, and isostearyl (meth)acrylate.

2-Ethylhexyl methacrylate and isodecyl methacrylate have particularly excellent decomposability compared with other long-chain alkyl methacrylates.

The lower limit of the amount of the segment derived from a (meth)acrylate containing an ester substituent having a carbon number of 8 or more in the (meth)acrylic resin (A) is preferably 1% by weight, more preferably 5% by weight and the upper limit thereof is preferably 15% by weight, more preferably 12% by weight, still more preferably 10% by weight.

The (meth)acrylic resin (A) may further contain a segment derived from a different (meth)acrylate in addition to the segments derived from isobutyl methacrylate, methyl methacrylate, ethyl methacrylate, n-butyl methacrylate, and the (meth)acrylate containing an ester substituent having a carbon number of 8 or more.

Examples of the different (meth)acrylate include alkyl (meth)acrylates containing an alkyl group having a carbon number of 2 to 6, graft monomers containing a polyalkylene ether chain in an ester substituent, polyfunctional (meth)acrylates, and (meth)acrylates containing a hydroxy group.

A (meth)acrylic resin containing a carboxy group-containing (meth)acrylate can improve the sheet strength but lowers the decomposability. Copolymerization with a carboxy group-containing (meth)acrylate is therefore not desirable.

In a preferred embodiment of the present invention, preferably, the (meth)acrylic resin (A) does not contain a segment derived from a monomer containing a polar functional group such as a carboxy group or a hydroxy group.

Examples of the alkyl (meth)acrylates containing an alkyl group having a carbon number of 2 to 6 include n-propyl (meth)acrylate, n-pentyl (meth)acrylate, and n-hexyl (meth)acrylate.

Examples of the graft monomers containing a polyalkylene ether chain in an ester substituent include polytetramethylene glycol monomethacrylate. The examples also include poly(ethylene glycol-polytetramethylene glycol) monomethacrylate, poly(propylene glycol-tetramethylene glycol) monomethacrylate, and propylene glycol-polybutylene glycol monomethacrylate. The examples also include methoxypolytetramethylene glycol monomethacrylate, methoxypoly(ethylene glycol-polytetramethylene glycol) monomethacrylate, methoxypoly(propylene glycol-tetramethylene glycol) monomethacrylate, and methoxypropylene glycol-polybutylene glycol monomethacrylate.

Examples of the (meth)acrylates containing a hydroxy group include 2-hydroxyethyl (meth)acrylate, hydroxypropyl (meth)acrylate, and hydroxybutyl (meth)acrylate.

The (meth)acrylic resin (A) may contain a segment derived from a glycidyl or epoxy group-containing (meth)acrylate.

The amount of the segment derived from a glycidyl or epoxy group-containing (meth)acrylate in the (meth)acrylic resin (A) is preferably 0 to 10% by weight, more preferably 0 to 5% by weight, still more preferably 0 to 3% by weight, still further more preferably 0 to 2% by weight, particularly preferably 0% by weight.

When the amount of the segment derived from a glycidyl or epoxy group-containing (meth)acrylate in the (meth)acrylic resin (A) is within the above range, the sinterability can be further improved.

A graft monomer containing a polyalkylene ether chain in an ester substituent may be included as a copolymerization component as it enhances decomposition of resins. However, a graft monomer having a hydroxy group at an end is not preferred as it contains a methacrylated bifunctional monomer.

The graft monomer containing a polyalkylene ether chain in an ester substituent is preferably a graft monomer containing a polyalkylene ether chain in an ester substituent in which an end of a glycol chain is ethoxylated or methoxylated.

When the copolymerization components include a crosslinking polyfunctional (meth)acrylate, a (meth)acrylic resin is not polymerized uniformly. Accordingly, the (meth)acrylic resin preferably does not contain a segment derived from a polyfunctional (meth)acrylate.

The (meth)acrylic resin (A) has a weight average molecular weight (Mw) of 1,000,000 or more.

When the (meth)acrylic resin (A) has a weight average molecular weight (Mw) of 1,000,000 or more, the resulting sheet can have higher elongation at break.

The lower limit of the weight average molecular weight (Mw) of the (meth)acrylic resin (A) is preferably 1,500,000, more preferably 2,000,000 and the upper limit thereof is preferably 7,000,000, more preferably 6,000,000, still more preferably 5,000,000.

When the weight average molecular weight (Mw) is 2,000,000 to 5,000,000, an inorganic fine particle-dispersed sheet obtained favorably contains less residual carbon and is easily formed into a thin film.

The (meth)acrylic resin (A) preferably has a ratio (Mw/Mn) of weight average molecular weight (Mw) to number average molecular weight (Mn) of 2.0 or less, more preferably 1.9 or less.

When the ratio is within such a range, the inorganic fine particle-dispersed slurry composition has favorable viscosity, so that the productivity is improved. Moreover, the resulting sheet can have proper strength.

The weight average molecular weight (Mw) and the number average molecular weight (Mn) can be measured by GPC using Column LF-804 (available from Showa Denko K.K.) as a column.

The (meth)acrylic resin (A) preferably has a glass transition temperature (Tg) of 40° C. or higher.

When the glass transition temperature is within the above range, the amount of a plasticizer to be added can be reduced, so that the (meth)acrylic resin can have improved decomposability at low temperature.

The lower limit of the glass transition temperature (Tg) is more preferably 40° C., still more preferably 45° C. and the upper limit thereof is preferably 60° C., more preferably 55° C., still more preferably 50° C.

The glass transition temperature (Tg) can be measured with, for example, a differential scanning calorimeter (DSC).

The upper limit of the 90% by weight decomposition temperature of the (meth)acrylic resin (A) in heating at 10° C./min is preferably 280° C.

When the 90% by weight decomposition temperature is 280° C. or lower, the (meth)acrylic resin (A) can achieve significantly high decomposability at low temperature and thus can reduce the time needed for debinding.

The lower limit of the 90% by weight decomposition temperature is preferably 230° C., more preferably 250° C. and the upper limit thereof is more preferably 270° C.

The 90% by weight decomposition temperature can be measured by, for example, TG-DTA.

The (meth)acrylic resin (A) molded into a sheet form having a thickness of 20 µm preferably has a maximum stress of 30 N/mm² or more in a tensile test.

The (meth)acrylic resin (A) molded into a sheet form having a thickness of 20 µm preferably shows yield stress and has an elongation at break of 50% or higher, more preferably 100% or higher.

The sheet having a thickness of 20 µm can be obtained by applying a resin solution containing a resin composition for sintering dissolved in a butyl acetate solution to a release-treated PET film using an applicator, followed by drying in a fan oven at 100° C. for 10 minutes. The maximum stress can be measured by a tensile test using an autograph. For example, the maximum stress can be measured under the conditions of 23° C. and 50 RH using a tensile tester (e.g., Autograph AG-IS, available from Shimadzu Corporation) at an inter-chuck distance of 3 cm at a pulling speed of 10 mm/min.

Since (meth)acrylic resins are usually hard and brittle, when they are molded into a sheet form and pulled, they break at a strain of less than 5%, not showing yield stress. In contrast, the (meth)acrylic resin (A) prepared by adjusting the formulation of a (meth)acrylic resin shows yield stress when molded into a sheet form and pulled.

The (meth)acrylic resin (A) preferably has a Z average particle size of 100 nm or more, more preferably 200 nm or more but preferably 1,000 nm or less, more preferably 700 nm or less.

The (meth)acrylic resin (A) preferably has a CV value of particle size of 20% or lower, more preferably 15% or lower, still more preferably 10% or lower. The lower limit is not limited. Still, the CV value is preferably 3% or higher, more preferably 4% or higher.

A smaller CV value of particle size indicates narrower molecular weight distribution of the (meth)acrylic resin and a smaller Mw/Mn. When the CV value of particle size is within the above range, viscosity control upon processing of the (meth)acrylic resin (A) into a resin solution is easy, so that the production conditions when the (meth)acrylic resin (A) is used in production of electronic products such as multilayer ceramic capacitors can be precisely controlled to enable production of higher-performance products.

The CV value of particle size can be calculated using the following expression. CV value (%) = [(standard deviation of particle size)/(average particle size)] × 100

The Z average particle size and the CV value of particle size can be measured using, for example, a Zetasizer.

The (meth)acrylic resin (A) is produced, for example, by a method of adding a specific polymerization initiator and a water-soluble surfactant added optionally to a monomer liquid mixture containing a raw material monomer mixture such as isobutyl methacrylate, methyl methacrylate, n-butyl methacrylate, and ethyl methacrylate dispersed in water and polymerizing the mixture.

In conventional production of (meth)acrylic resins, monomers are polymerized by emulsion polymerization in a dispersant micelle. For production of a high-molecular-weight resin, a big micelle needs to be formed, which requires addition of a large amount of dispersant. A (meth)acrylic resin thus obtained contains a large amount of dispersant to disadvantageously have poor sinterability and give insufficient sheet strength.

In the present invention, raw material monomers dispersed in water are polymerized using a specific polymerization initiator, which enables production of a particulate (meth)acrylic resin without using a dispersant. Moreover, a (meth)acrylic resin having a higher molecular weight than (meth)acrylic resins produced by conventional emulsion polymerization can be produced.

The polymerization initiator used may be a water-soluble radical polymerization initiator containing at least one selected from the group consisting of a sulfone group, a sulfonyl group, a sulfine group, an imidazoline group, a carboxy group, an amide group, and a hydroxy group.

Polymerization using the polymerization initiator, i.e., the water-soluble radical polymerization initiator enables production of a high-molecular-weight (meth)acrylic resin without addition of a large amount of dispersant as in conventional emulsion polymerization.

In the polymerization reaction, monomers dispersed in water are polymerized starting from the water-soluble radical polymerization initiator. Here, in order to avoid collision or agglomeration of monomers, dispersion polymerization is carried out at low concentration. Such a reaction can provide a polymer having uniform components and a uniform particle size. In the method, polymerization is carried out at low concentration using the water-soluble radical polymerization initiator, which can minimize a reaction that causes nonuniformity (e.g., hydrogen abstraction), thus interfering with the growth of multiple polymers in the reaction system.

Examples of the water-soluble radical polymerization initiator include: acid mixtures of imidazole azo compounds such as 2,2′-azobis[2-(2-imidazolin-2-yl)propane]dihydrochloride, 2,2′-azobis[2-(2-imidazolin-2-yl)propane]sulfate hydrate, and 2,2′-azobis[2-(2-imidazolin-2-yl)propane]; water-soluble azo compounds such as 2,2′-azobis(2-methylpropioneamidine)dihydrochloride, 2,2′-azobis[N-(2-carboxyethyl)-2-methylpropionamidine]tetrahydrate, 2,2′-azobis[2-methyl-N-(2-hydroxyethyl)propionamide], and 4,4′-azobis-4-cyanovaleric acid; oxo acids such as potassium persulfate (potassium peroxodisulfate), ammonium persulfate (ammonium peroxodisulfate), and sodium persulfate (sodium peroxodisulfate); and peroxides such as hydrogen peroxide, peracetic acid, performic acid, and perpropionic acid. Preferred among these are acid mixtures of imidazole azo compounds, water-soluble azo compounds, and oxo acids. More preferred are 2,2′-azobis[2-(2-imidazolin-2-yl)propane]dihydrochloride, 2,2′-azobis(2-methylpropionamidine)dihydrochloride, 2,2′-azobis[N-(2-carboxyethyl)-2-methylpropioneamidine]tetrahydrate, 2,2′-azobis[2-methyl-N-(2-hydroxyethyl)propionamide], potassium persulfate, ammonium persulfate, and sodium persulfate. In order to further reduce residues, still more preferred are potassium persulfate and ammonium persulfate.

These water-soluble radical polymerization initiators may be used alone or in combination of two or more.

The above method also enables production of a (meth)acrylic resin having a weight average molecular weight within a predetermined range. The weight average molecular weight of the (meth)acrylic resin may be adjusted by adding a chain transfer agent or a polymerization terminator.

Any chain transfer agent or polymerization terminator may be used. Examples include sodium 3-mercapto-1-propanesulfonate, mercaptosuccinic acid, mercaptopropanediol, (allylsulfonyl)benzene, 2-mercaptoethanesulfinic acid ethyl ester, and 3-mercaptopropionamide.

Addition of the chain transfer agent or polymerization terminator enables production of a (meth)acrylic resin having at least one selected from the group consisting of a sulfone group, a sulfonyl group, a sulfine group, an imidazoline group, a carboxy group, an amide group, and a hydroxy group at at least one molecular end of the main chain and having a weight average molecular weight within a predetermined range.

The amount of the water-soluble radical polymerization initiator added is preferably 0.03 to 0.2 parts by weight, more preferably 0.05 to 0.15 parts by weight per 100 parts by weight of the raw material monomers.

When the amount is 0.03 parts by weight or more, the reaction rate of the raw material monomers can be sufficiently increased. When the amount is 0.2 parts by weight or less, the molecular weight of the (meth)acrylic resin can be sufficiently increased.

When the amount is within the above range, a (meth)acrylic resin having at least one selected from the group consisting of a sulfone group, a sulfonyl group, a sulfine group, an imidazoline group, a carboxy group, an amide group, and a hydroxy group at a molecular end (at the ω position) is dispersed in water at low concentration to enable production of a resin having a uniform particle size.

In emulsion polymerization, normally, a water-soluble surfactant is added in an amount of 1 part by weight or more per 100 parts by weight of raw material monomers. The amount is preferably smaller because a water-soluble surfactant serves as a foreign substance in molding of a resin sheet. However, simple reduction of the amount of a water-soluble surfactant is insufficient to enable polymerization of a high-molecular-weight resin. When the amount of the water-soluble radical polymerization initiator is within the above range, polymerization domains remain dispersed in water with no or little addition of an emulsifier, enabling production of a (meth)acrylic resin having a very high molecular weight.

The amount of the raw material monomers added is preferably 50 to 300 parts by weight per 1,000 parts by weight of water.

When the amount is within the above range, aggregation during polymerization or adhesion of resin to the reaction vessel can be prevented.

The amount of the raw material monomers added is more preferably 70 to 200 parts by weight per 1,000 parts by weight of water.

When the amount is within the above range, residual monomers can be reduced to achieve uniform polymerization.

The raw material monomer mixture is dispersed in water, for example, by stirring using a stirring blade under the condition of 100 to 250 rpm.

The temperature during the polymerization is preferably 50° C. to 100° C.

When the temperature is 50° C. or higher, the polymerization reaction proceeds satisfactory. When the temperature is 80° C. or lower, the resin is prevented from agglomeration to obtain uniform resin particles.

In the polymerization, the raw material monomers are held at a predetermined temperature for several hours to be dispersed in water from the polar functional group at a monomer end as a base point, thereby forming more uniform resin particles.

Resin particles obtainable by conventional synthesis in water have a CV value of particle size of about 15 to 40%. In contrast, the resin particles obtained by the above method have a CV value of particle size of 20% or lower, being more uniform resin particles. The CV value is a value indicating a ratio of the standard deviation to the average particle size. When the CV value is large, supply of monomers to polymerization domains growing in water upon production of resin particles is not uniform, which suggests presence of both domains which grow easily and domains which are not likely to grow. In such a case, the resulting resin has an average molecular weight of at most about 1,000,000.

In the case of the (meth)acrylic resin in the present invention, the ratio of the initiator to monomers is optimized, so that supply of monomers to polymerization domains is uniform. Accordingly, a resin having an average molecular weight of 2,000,000 or more can be synthesized.

The (meth)acrylic resin obtained by the above method has an extremely small average particle size of 0.01 to 0.2 µm and therefore are difficult to recover with a filtering material such as a filter cloth. The (meth)acrylic resin is preferably recovered by centrifugation, freeze drying, spray drying, or the like. Examples of the recovery method may also include a method of adding an alcohol (e.g., butanol, hexanol) or an organic solvent (e.g., methyl acetate) to the solution containing resin particles after the reaction and swelling and aggregating the resin for recovery, a method of adding an organic salt (e.g., sodium acetate, sodium sulfonate) to precipitate the resin, and a method of dehydrating the solution after the reaction under reduced pressure to increase the resin concentration for precipitation and drying the precipitated resin.

The binder resin may contain a (meth)acrylic resin (B) having a weight average molecular weight (Mw) of 1,000,000 or less.

The (meth)acrylic resin (B) contained advantageously facilitate adjustment of sheet properties.

The (meth)acrylic resin (B) preferably has a weight average molecular weight (Mw) of less than 1,000,000, more preferably 500,000 or less, still more preferably 300,000 or less, still further more preferably 100,000 or less.

Monomer components constituting the (meth)acrylic resin (B) may be the same as those of the (meth)acrylic resin (A).

The weight ratio of the (meth)acrylic resin (A) to the (meth)acrylic resin (B) in the binder resin is preferably 99:1 to 50:50.

When the weight ratio is within the above range, achievement of both high yield stress and high elongation at break is advantageously facilitated.

The weight ratio is more preferably 70:30 to 50:50.

The amount of the water-soluble surfactant in the resin composition for sintering of the present invention is 0 parts by weight or more and 0.02 parts by weight or less per 100 parts by weight of the binder resin.

The water-soluble surfactant is preferably a surfactant having a solubility in water at 25° C. of 10 g/100 g or more.

When the amount of the water-soluble surfactant is set to, for example, 0.02 parts by weight or less, the (meth)acrylic resin dissolved in an organic solvent has a low haze, enabling achievement of both the sinterability and the sheet strength.

The amount of the water-soluble surfactant is preferably 0.015 parts by weight or less per 100 parts by weight of the binder resin.

The lower limit is 0 parts by weight or more. Addition of a slight amount of the water-soluble surfactant can reduce or prevent adhesion of the resin to the polymerization tank or blades. Therefore, the water-soluble surfactant may be added only in a slight amount. The amount is preferably, for example, 0.000005 parts by weight or more, more preferably 0.00005 parts by weight or more, still more preferably 0.005 parts by weight or more.

The amount of the water-soluble surfactant may be measured by any method. Examples of the method include a method of using liquid chromatography such as HPLC and an extraction method using methanol or the like. It may also be measured based on the amount of decomposition gas at 400° C. to 600° C. derived from combustion of the water-soluble surfactant and the amount of decomposition gas at 200° C. to 300° C. derived from decomposition of the (meth)acrylic resin, using a thermogravimetry mass spectrometer.

The water-soluble surfactant is used as a dispersant added in emulsion polymerization. Examples thereof include anionic surfactants such as alkyl sulfonates and polymeric surfactants such as polyvinyl alcohol, polyvinyl butyral, and polyalkylene glycol.

Examples of the alkyl sulfonates include sodium salts, potassium salts, and ammonium salts of octylsulfonic acid, decylsulfonic acid, and dodecylsulfonic acid.

In the case where the resin composition for sintering of the present invention is formed into a resin solution, the resin solution is clouded slightly according to the amount of the water-soluble surfactant. Since the (meth)acrylic resin (A) has a very high molecular weight, a reduction of the solubility of the resin composition in a solvent also makes the resin solution clouded.

Whether the resin solution is suitable for molding of an inorganic fine particle-dispersed sheet thus can be determined based on the haze. A resin solution (resin component: 10% by weight) having a haze of 10% or higher at normal temperature is not suitable for production of an inorganic fine particle-dispersed sheet.

The resin composition for sintering of the present invention may further contain an organic solvent.

Any organic solvent may be used. Examples thereof include toluene, ethyl acetate, butyl acetate, pentyl acetate, hexyl acetate, ethyl butyrate, butyl butyrate, pentyl butyrate, hexyl butyrate, isopropanol, methyl isobutyl ketone, methyl ethyl ketone, methyl isobutyl ketone, ethylene glycol ethyl ether, ethylene glycol monobutyl ether, ethylene glycol monoethyl ether acetate, diethylene glycol monoethyl ether, diethylene glycol monomethyl ether, diethylene glycol monoisobutyl ether, trimethylpentanediol monoisobutyrate, butyl carbitol, butyl carbitol acetate, terpineol, terpineol acetate, dihydroterpineol, dihydroterpineol acetate, texanol, isophorone, butyl lactate, dioctyl phthalate, dioctyl adipate, benzyl alcohol, phenyl propylene glycol, and cresol. Preferred among these are butyl acetate, terpineol, terpineol acetate, dihydroterpineol, dihydroterpineol acetate, diethylene glycol monoethyl ether, diethylene glycol monomethyl ether, diethylene glycol monoisobutyl ether, butyl carbitol, butyl carbitol acetate, and texanol. More preferred are butyl acetate, terpineol, terpineol acetate, dihydroterpineol, and dihydroterpineol acetate. These organic solvents may be used alone or in combination of two or more.

The organic solvent preferably has a boiling point of 70° C. or higher.

When the boiling point is 70° C. or higher, the organic solvent is not evaporated too early and thus has excellent handleability.

The boiling point is more preferably 90° C. to 230° C., still more preferably 95° C. to 200° C., still further more preferably 100° C. to 180° C., particularly preferably 105° C. to 150° C.

When the boiling point is within the above range, the resulting sheet can have improved strength.

From the standpoint of sinterability at low temperature, the resin composition for sintering of the present invention preferably contains substantially no polymerization initiator.

The resin composition for sintering of the present invention adjusted to have a binder resin content of 10% by weight preferably has a haze of lower than 10%.

When the haze is within the above range, the sheet strength is advantageously increased.

The haze is preferably 0% or higher, more preferably 9% or lower, still more preferably 7% or lower, still further more preferably 5% or lower.

The resin composition for sintering of the present invention molded into a sheet form having a thickness of 20 µm preferably has a maximum stress of 30 N/mm² or more in a tensile test.

The resin composition for sintering of the present invention molded into a sheet form having a thickness of 20 µm preferably shows yield stress and preferably has an elongation at break of 50% or higher, more preferably 100% or higher.

The sheet having a thickness of 20 µm can be obtained by applying a resin solution containing the resin composition for sintering of the present invention dissolved in a butyl acetate solution to a release-treated PET film using an applicator, followed by drying in a fan oven at 100° C. for 10 minutes. The maximum stress can be measured by the same method as that employed in the tensile test for the (meth)acrylic resin (A).

Since (meth)acrylic resins are usually hard and brittle, when they are molded into a sheet form and pulled, they break at a strain of less than 5%, not showing yield stress. In contrast, the resin composition for sintering of the present invention prepared by adjusting the formulation of a resin composition for sintering shows yield stress when molded into a sheet form and pulled.

The resin composition for sintering of the present invention preferably has a Z average particle size of 100 nm or more, more preferably 200 nm or more and preferably 1,000 nm or less, more preferably 700 nm or less.

The resin composition for sintering of the present invention preferably has a CV value of particle size of 20% or lower, more preferably 15% or lower, still more preferably 10% or lower. The lower limit is not limited. Still, the CV value is preferably 3% or higher, more preferably 4% or higher.

A smaller CV value of particle size indicates narrower molecular weight distribution of the (meth)acrylic resin and a smaller Mw/Mn. When the CV value of particle size is within the above range, viscosity control upon processing of the resin composition for sintering into a resin solution is easy, so that the production conditions when the resin composition for sintering is used in production of electronic products such as multilayer ceramic capacitors can be precisely controlled to enable production of higher-performance products.

The Z average particle size and the CV value of particle size can be measured, for example, by using a Zetasizer.

An inorganic fine particle-dispersed slurry composition can be produced by using inorganic fine particles and the resin composition for sintering of the present invention containing a binder resin and an organic solvent.

The present invention also encompasses an inorganic fine particle-dispersed slurry composition containing the resin composition for sintering of the present invention and inorganic fine particles.

The amount of the binder resin in the inorganic fine particle-dispersed slurry composition of the present invention is not limited. The lower limit thereof is preferably 5% by weight and the upper limit thereof is preferably 30% by weight.

When the amount of the binder resin is within the above range, the inorganic fine particle-dispersed slurry composition can be debinded even by firing at low temperature.

The lower limit of the amount of the binder resin is more preferably 6% by weight and the upper limit thereof is more preferably 12% by weight.

The inorganic fine particle-dispersed slurry composition of the present invention contains the organic solvent.

The amount of the organic solvent in the inorganic fine particle-dispersed slurry composition of the present invention is not limited. The lower limit thereof is preferably 10% by weight and the upper limit thereof is preferably 60% by weight. When the amount is within the above range, the coating properties and the inorganic fine particle dispersibility can be improved.

The inorganic fine particle-dispersed slurry composition of the present invention contains inorganic fine particles.

Any inorganic fine particles may be used. Examples thereof include glass powder, ceramic powder, phosphor fine particles, silicon oxide, and metal fine particles.

Any glass powder may be used. Examples thereof include powders of glass such as bismuth oxide glass, silicate glass, lead glass, zinc glass, or boron glass, and various silicon oxide glass powders such as CaO—Al₂O₃—SiO₂ glass powder, MgO—Al₂O₃—SiO₂ glass powder, and LiO₂—Al2O₃—SiO₂ glass powder.

Usable glass powders include SnO—B₂O₃—P₂O₃—Al₂O₃ mixtures, PbO—B₂O₃—SiO2 mixtures, BaO—ZnO—B₂O₃—SiO₂ mixtures, ZnO—Bi₂O₃—B₂O₃—SiO₂ mixtures, Bi₂O₃—B₂O₃—BaO—CuO mixtures, Bi₂O₃—ZnO—B₂O₃—Al₂O₃—SrO mixtures, ZnO—Bi₂O₃—B₂O₃ mixtures, Bi₂O₃—SiO₂ mixtures, P₂O₅—Na₂O—CaO—BaO—Al₂O₃—B₂O₃ mixtures, P₂O₅—SnO mixtures, P₂O₅—SnO—B₂O₃ mixtures, P₂O₅—SnO—SiO₂ mixtures, CuO—P₂O₅—RO mixtures, SiO₂—B₂O₃—ZnO—Na₂O—Li₂O—NaF—V₂O₅ mixtures, P₂O₅—ZnO—SnO—R₂O—RO mixtures, B₂O₃—SiO₂—ZnO mixtures, B₂O₃—SiO₂—Al₂O₃—ZrO₂ mixtures, SiO₂—B₂O₃—ZnO—R₂O—RO mixtures, SiO₂—B₂O₃—Al₂O₃—RO—R₂O mixtures, SrO—ZnO—P₂O₅ mixtures, SrO—ZnO—P₂O₅ mixtures, and BaO—ZnO—B₂O₃—SiO₂ mixtures. R is an element selected from the group consisting of Zn, Ba, Ca, Mg, Sr, Sn, Ni, Fe, and Mn.

Particularly preferred are PbO—B₂O₃—SiO₂ mixture glass powders and lead-free glass powders such as BaO—ZnO—B₂O₃—SiO₂ mixtures or ZnO—Bi₂O₃—B₂O₃—SiO₂ mixtures.

Any ceramic powder may be used. Examples thereof include alumina, ferrite, zirconia, zircon, barium zirconate, calcium zirconate, titanium oxide, barium titanate, strontium titanate, calcium titanate, magnesium titanate, zinc titanate, lanthanum titanate, neodymium titanate, lead zirconate titanate, alumina nitride, silicon nitride, boron nitride, boron carbide, barium stannate, calcium stannate, magnesium silicate, mullite, steatite, cordierite, and forsterite.

Usable ceramic powders also include ITO, FTO, niobium oxide, vanadium oxide, tungsten oxide, lanthanum strontium manganite, lanthanum strontium cobalt ferrite, yttrium-stabilized zirconia, gadolinium-doped ceria, nickel oxide, and lanthanum chromite.

Any phosphor fine particles may be used. For example, the phosphor may be a blue phosphor, a red phosphor, or a green phosphor conventionally known as a phosphor for displays. Examples of the blue phosphor include MgAl₁₀O₁₇:Eu phosphors, Y₂SiO₅:Ce phosphors, CaWO₄: Pb phosphors, BaMgAl₁₄O₂₃:Eu phosphors, BaMgAl₁₆O₂₇:Eu phosphors, BaMg₂Al₁₄O₂₃:Eu phosphors, BaMg₂Al₁₄O₂₇:Eu phosphors, and ZnS: (Ag,Cd) phosphors. Examples of the red phosphor include Y₂O₃:Eu phosphors, Y₂SiO₅:Eu phosphors, Y₃Al₅O₁₂:Eu phosphors, Zn₃(PO₄)₂:Mn phosphors, YBO₃:Eu phosphors, (Y,Gd)BO₃:Eu phosphors, GdBO₃:Eu phosphors, ScBO₃:Eu phosphors, and LuBO₃:Eu phosphors. Examples of the green phosphor include Zn₂SiO₄:Mn phosphors, BaAl₁₂O₁₉:Mn phosphors, SrAl₁₃O₁₉:Mn phosphors, CaAl₁₂O₁₉ :Mn phosphors, YBO₃: Tb phosphors, BaMgAl₁₄O₂₃:Mn phosphors, LuBO₃:Tb phosphors, GdBO₃:Tb phosphors, ScBO₃:Tb phosphors, and Sr₆Si₃O₃Cl₄:Eu phosphors. Other usable phosphors include ZnO:Zn phosphors, ZnS: (Cu,Al) phosphors, ZnS:Ag phosphors, Y₂O₂S:Eu phosphors, ZnS: Zn phosphors, (Y,Cd)BO₃:Eu phosphors, and BaMgAl₁₂O₂₃:Eu phosphors.

Any metal fine particles may be used. Examples thereof include powders of copper, nickel, palladium, platinum, gold, silver, aluminum, and tungsten, and alloys thereof.

Metals such as copper and iron have good adsorption properties with a carboxy group, an amino group, an amide group, and the like, and are easily oxidized. Such metals can also be suitably used. These metal powders may be used alone or in combination of two or more.

A metal complex, any of various carbon blacks and carbon nanotubes, or the like may be used.

The inorganic fine particles preferably contain lithium or titanium. Specific examples include low-melting-point glass such as LiO₂—A1₂O₃—SiO₂ inorganic glass, lithium sulfur glass such as Li₂S-MₓS_{y} (M = B, Si, Ge, or P), lithium cobalt complex oxides such as LiCoO₂, lithium manganese complex oxides such as LiMnO₄, lithium nickel complex oxides, lithium vanadium complex oxides, lithium zirconium complex oxides, lithium hafnium complex oxides, lithium silicophosphate (Li_{3.5}Si_{0.5}P_{0.5}O₄), titanium lithium phosphate (LiTi₂(PO₄)₃), lithium titanate (Li₄Ti₅O₁₂), Li_{4/3}Ti_{5/3}O₄, germanium lithium phosphate (LiGe₂(PO₄)₃), Li₂—SiS glass, Li₄GeS₄—Li₃PS₄ glass, LiSiO₃, LiMn₂O₄, Li₂S-P₂S₅ glass/ceramics, Li₂O—SiO₂, Li₂O—V₂O₅—SiO₂, LiS—SiS₂—Li₄SiO₄ glass, ion conductive oxides such as LiPON, lithium oxide compounds such as Li₂O—P₂O₅—B₂O₃, Li₂O—GeO₂Ba, LiₓAl_{y}Ti_{z}(PO₄)₃ glass, LaₓLi_{y}TiO_{z} glass, LiₓGe_{y}P_{z}O₄ glass, Li₇La₃Zr₂O₁₂ glass, LiᵥSi_{w}PₓS_{y}Cl_{z} glass, lithium niobium oxides such as LiNbO₃, lithium alumina compounds such as Li-β-alumina, and lithium zinc oxides such as Li₁₄Zn(GeO₄)₄.

The amount of the inorganic fine particles in the inorganic fine particle-dispersed slurry composition of the present invention is not limited. The lower limit thereof is preferably 10% by weight and the upper limit thereof is preferably 90% by weight. When the amount is 10% by weight or more, the inorganic fine particle-dispersed slurry composition can have sufficient viscosity and excellent coating properties. When the amount is 90% by weight or less, excellent inorganic fine particle dispersibility can be obtained.

The inorganic fine particle-dispersed slurry composition of the present invention preferably contains a plasticizer.

Examples of the plasticizer include monomethyl adipate, di(butoxyethyl) adipate, dibutoxyethoxy ethyl adipate, triethylene glycol bis(2-ethylhexanoate), triethylene glycol dihexanoate, triethyl acetylcitrate, tributyl acetylcitrate, and dibutyl sebacate.

Use of any of these plasticizers can reduce the amount of the plasticizer added compared with the case of usnig a conventional plasticizer (the amount relative to the binder resin can be reduced from about 30% by weight to 25% by weight or less, or further to 20% by weight or less).

In particular, a non-aromatic plasticizer is preferably used. The plasticizer more preferably contains a component derived from adipic acid, triethylene glycol, or citric acid. Plasticizers containing an aromatic ring are not preferred because they easily produce soot when burnt.

The plasticizer preferably has a boiling point of 240° C. or higher and lower than 390° C. When the boiling point is 240° C. or higher, the plasticizer is easily evaporated in a drying step, so that remaining of the plasticizer in the molded article can be prevented. When the boiling point is lower than 390° C., production of residual carbon can be prevented. The boiling point means a boiling point at normal pressure.

The amount of the plasticizer in the inorganic fine particle-dispersed slurry composition of the present invention is not limited. The lower limit thereof is preferably 0.1% by weight and the upper limit thereof is preferably 3.0% by weight. When the amount is within the above range, firing residues of the plasticizer can be reduced.

The inorganic fine particle-dispersed slurry composition of the present invention may have any viscosity. The lower limit of the viscosity measured at 20° C. using a B-type viscometer at a probe rotation frequency of 5 rpm is preferably 0.1 Pa·s and the upper limit thereof is preferably 100 Pa ·s.

When the viscosity is 0.1 Pa ·s or higher, after the inorganic fine particle-dispersed slurry composition is applied by a die-coating printing method or the like, the resulting inorganic fine particle-dispersed sheet can maintain a predetermined shape. When the viscosity is 100 Pa ·s or lower, trouble such as remaining of die discharge marks can be prevented, and excellent printability can be obtained.

The inorganic fine particle-dispersed slurry composition of the present invention may be produced by any method, and may be produced by a conventionally known stirring method. Specifically, in an exemplary method, the resin composition for sintering of the present invention, the inorganic fine particles, and optionally added components including an organic solvent, a plasticizer, and other components are stirred with a triple roll mill or the like.

An inorganic fine particle-dispersed sheet can be produced by applying the inorganic fine particle-dispersed slurry composition of the present invention to a support film whose one surface is release-treated, and drying the organic solvent to shape the composition into a sheet form. The present invention also encompasses such an inorganic fine particle-dispersed sheet.

The inorganic fine particle-dispersed sheet of the present invention preferably has a thickness of 1 to 20 µm.

The support film used in production of the inorganic fine particle-dispersed sheet of the present invention is preferably a resin film having flexibility as well as heat resistance and solvent resistance. When the support film has flexibility, the inorganic fine particle-dispersed slurry composition can be applied to a surface of the support film with a roll coater, a blade coater, or the like, and the resulting film with the formed inorganic fine particle-dispersed sheet can be stored and supplied in the form of a wound roll.

Examples of the resin forming the support film include polyethylene terephthalate, polyester, polyethylene, polypropylene, polystyrene, polyimide, polyvinyl alcohol, polyvinyl chloride, fluororesin such as polyfluoroethylene, nylon, and cellulose.

The support film preferably has a thickness of, for example 20 to 100 µm.

A surface of the support film is preferably release-treated. Such a treatment allows easy separation of the support film in a transfer step.

An all-solid-state battery can be produced by using the inorganic fine particle-dispersed slurry composition and the inorganic fine particle-dispersed sheet of the present invention as materials of a positive electrode, a solid electrolyte, and a negative electrode of the all-solid-state battery. A multilayer ceramic capacitor can be produced by using the inorganic fine particle-dispersed slurry composition and the inorganic fine particle-dispersed sheet of the present invention for dielectric green sheets and an electrode paste.

The method for producing an all-solid state battery preferably includes: preparing an electrode active material sheet by molding a slurry for an electrode active material layer, the slurry containing an electrode active material and a binder for an electrode active material layer; laminating the electrode active material sheet and the inorganic fine particle-dispersed sheet of the present invention to prepare a laminate: and firing the laminate.

Any electrode active material may be used. For example, the same inorganic fine particles as described above may be used.

The binder for an electrode active material layer may be the binder resin described above.

The electrode active material sheet and the inorganic fine particle-dispersed sheet of the present invention may be laminated by performing, after forming the respective sheets, thermal pressure bonding by hot press or performing thermal lamination.

In the firing step, the lower limit of the heating temperature is preferably 250° C. and the upper limit thereof is preferably 350° C.

The all-solid state battery can be obtained by the above production method.

The all-solid state battery preferably has a laminated structure including a positive electrode layer containing a positive electrode active material, a negative electrode layer containing a negative electrode active material, and a solid electrolyte layer formed between the positive electrode layer and the negative electrode layer.

The method for producing the multilayer ceramic capacitor preferably includes: preparing dielectric sheets by printing and drying a conductive paste on the inorganic fine particle-dispersed sheet of the present invention; and laminating the dielectric sheets.

The conductive paste contains a conductive powder.

The conductive powder may be formed of any material that has conductivity. Examples thereof include nickel, palladium, platinum, gold, silver, copper, and alloys thereof. These conductive powders may be used alone or in combination of two or more.

The binder resin and organic solvent used in the conductive paste may be the same as those for the inorganic fine particle-dispersed slurry composition of the present invention.

The conductive paste may be printed by any method. Examples of the method include a screen printing method, a die-coating printing method, an offset printing method, a gravure printing method, and an ink-jet printing method.

In the method for producing the multilayer ceramic capacitor, a multilayer ceramic capacitor can be obtained by laminating the dielectric sheets on which the conductive paste is printed.

### Advantageous Effects of Invention

The present invention can provide a resin composition for sintering which has excellent decomposability at low temperature, can provide a molded article having high strength, and enables an increase in the number of layers and thinning so as to enable production of a ceramic laminate having excellent properties. The present invention can also provide an inorganic fine particle-dispersed slurry composition containing the resin composition for sintering, and an inorganic fine particle-dispersed sheet formed using the resin composition for sintering or the inorganic fine particle-dispersed slurry composition.

### DESCRIPTION OF EMBODIMENTS

The present invention is more specifically described in the following with reference to, but not limited to, examples.

### Example 1

A 2-L separable flask equipped with a stirrer, a condenser, a thermometer, a water bath, and a nitrogen gas inlet was provided. The 2-L separable flask was charged with 900 parts by weight of water and monomers including 70 parts by weight of isobutyl methacrylate (iBMA) and 30 parts by weight of ethyl methacrylate (EMA). The contents were stirred with a stirring blade under the condition of 150 rpm, so that monomers were dispersed in water. Thus, a monomer liquid mixture was obtained.

The obtained monomer liquid mixture was bubbled with nitrogen gas for 20 minutes to remove dissolved oxygen. Thereafter, the separable flask system was purged with nitrogen gas, and the temperature was raised with stirring until the water bath reached 80° C. Thereto was added a solution of 0.01 parts by weight of ammonium dodecylsulfonate (DSA, solubility in water at 25° C.: 10 g/100 g) as a water-soluble surfactant and 0.08 parts by weight of ammonium persulfate (APS) as a polymerization initiator in 20 parts by weight of water, thereby initiating polymerization. Seven hours after the start of the polymerization, the contents of the flask were cooled to room temperature to complete the polymerization. Thus, an aqueous solution containing a (meth)acrylic resin having a sulfone group at one molecular end of the main chain was obtained.

A 2-g portion of the obtained resin aqueous solution wad dried in an oven at 150° C. to determine the resin solid content. The aqueous solution had a resin solid content concentration of 10% by weight and it was confirmed that all the monomers used were reacted.

The obtained aqueous solution was dried using a spray dryer. Thus, a resin composition for sintering was obtained.

### Examples 2 to 14, Comparative Examples 1 to 9

A resin composition for sintering was obtained as in Example 1, except that the types and amounts of the monomers, water-soluble surfactant, polymerization initiator, chain transfer agent, and polymerization terminator used were changed as shown in Table 1 or 2. The chain transfer agent and the polymerization initiator were added simultaneously with the addition of monomers to water.

The monomers, water-soluble surfactants, polymerization initiators, chain transfer agents, and polymerization terminators used are listed below.

### Monomer

MMA: methyl methacrylate nBMA: n-butyl methacrylate 2EHMA: 2-ethylhexyl methacrylate iDMA: isodecyl methacrylate HEMA: 2-hydroxyethyl methacrylate MPOMA: methoxypolypropyleneglycol methacrylate

### Water-Soluble Surfactant

DSN: sodium dodecyl sulfonate (solubility in water at 25° C.: 10 g/100 g) PVA: GOHSENOL Z-210 (available from Mitsubishi Chemical Corporation, solubility in water at 25° C.: 30 g/100 g)

### Polymerization Initiator

KPS: potassium persulfate (available from FUJIFILM Wako Pure Chemical Corporation.) NaPS: sodium persulfate (available from FUJIFILM Wako Pure Chemical Corporation.) VA-044: 2,2′-azobis[2-(2-imidazolin-2-yl)propane]dihydrochloride (available from FUJIFILM Wako Pure Chemical Corporation.) V-50: 2,2′-azobis(2-methylpropionamidine)dihydrochloride (available from FUJIFILM Wako Pure Chemical Corporation.) VA-057: 2,2′-azobis[N-(2-carboxyethyl)-2-methylpropionamidine]tetrahydrate (available from FUJIFILM Wako Pure Chemical Corporation.) VA-086: 2,2′-azobis[2-methyl-N-(2-hydroxyethyl)propionamide] (available from FUJIFILM Wako Pure Chemical Corporation.) PEROYL SA: disuccinic acid peroxide (available from NOF Corporation) PEROYL IPP: isopropyl peroxydicarbonate (available from NOF Corporation)

### Polymerization Terminator

ASB: (allylsulfonyl)benzene AC: allyl octanoate <Chain transfer agent> MESE: 2-mercaptoethanesulfinic acid ethyl ester MPA: 3-mercaptopropionamide

TABLE 1

| | Monomer | | | | | | | | Chain transfer agent/ Polymerization terminator | | | | Water-soluble surfactant | | | Polymerization initiator | | | | | | | | |
|---|---|---|---|---|---|---|---|---|---|---|---|---|---|---|---|---|---|---|---|---|---|---|---|---|
| | iBMA | MMA | EMA | nBMA | 2EHMA | iDMA | HEMA | MPOMA | MESE | MPA | ASB | AC | DSN | PVA | DSA | KPS APS | | NaPS | VA-044 | V-50 | VA-057 | VA-086 | PEROYL SA | PEROYL IPP |
| Example 1 | 70 | | 30 | | | | | | | | | | | | 0.01 | | 0.08 | | | | | | | |
| Example 2 | 60 | | | 40 | | | | | | | | | | | | | | 0.1 | | | | | | |
| Example 3 | 40 | 30 | | 30 | | | | | | | | | | | | | | | 0.12 | | | | | |
| Example 4 | 50 | | 20 | 30 | | | | | | | | | | | | 0.2 | | | | | | | | |
| Example 5 | 70 | | 20 | | 10 | | | | | | | | | | | | | | | 0.15 | | | | |
| Example 6 | 60 | 10 | | 20 | | 10 | | | | | | | | | 0.01 | | | | | | 0.05 | | | |
| Example 7 | 50 | 10 | | 20 | | | 10 | 10 | | | | | 0.02 | | | | | | | | | 0.03 | | |
| Example 8 | 40 | | 5 | 55 | | | | | | | | | 0.01 | | | 0.15 | | | | | | | | |
| Example 9 | 45 | 35 | | 20 | | | | | | | | | 0.01 | | | 0.15 | | | | | | | | |
| Example 10 | 50 | | 40 | 10 | | | | | | | | | 0.01 | | | 0.02 | | | | | | | | |
| Example 11 | 50 | | 40 | 10 | | | | | | | | | 0.01 | | | 0.15 | | | | | | | | |
| Example 12 | 50 | | 40 | 10 | | | | | | | 0.2 | | 0.01 | | | | | | | | | | | 0.2 |
| Example 13 | 50 | | 40 | 10 | | | | | 0.2 | | | | 0.01 | | | | | | | | | | | 0.2 |
| Example 14 | 50 | | 40 | 10 | | | | | | 0.2 | | | 0.01 | | | | | | | | | | | 0.2 |

TABLE 2

| | Monomer | | | | | | | | Chain transfer agent/ Polymerization terminator | | | | Water-soluble surfactant | | | Polymerization initiator | | | | | | | | |
|---|---|---|---|---|---|---|---|---|---|---|---|---|---|---|---|---|---|---|---|---|---|---|---|---|
| | iBMA | MMA | EMA | nBMA | 2EHMA | iDMA | HEMA | MPOMA | MESE | MPA | ASB | AC | DSN | PVA | DSA | KPS | APS | NaPS | VA-044 | V-50 | VA-057 | VA-086 | PEROYL SA | PEROYL IPP |
| Comparative Example 1 | 30 | 70 | | | | | | | | | | | 0.08 | | | 0.3 | | | | | | | | |
| Comparative Example 2 | 30 | | 70 | | | | | | | | | | | 1 | | | | | | 0.02 | | | | |
| Comparative Example 3 | 30 | | | 70 | | | | | | | | | 0.03 | | | | 0.1 | | | | | | | |
| Comparative Example 4 | 30 | 50 | | 20 | | | | | | | | | 0.03 | | | | 0.2 | | | | | | | |
| Comparative Example 5 | 30 | | 50 | 20 | | | | | | | | | | 1 | | | 0.2 | | | | | | | |
| Comparative Example 6 | 20 | 35 | | 45 | | | | | | | | | 0.01 | | | | | | | | | | | 0.03 |
| Comparative Example 7 | 20 | 35 | | 45 | | | | | | | | 0.03 | 0.01 | | | | | | | | | | 0.03 | |
| Comparative Example 8 | 20 | 35 | | 45 | | | | | | | | | 0.01 | | | 0.3 | | | | | | | | |
| Comparative Example 9 | 20 | 35 | | 45 | | | | | | | | | 0.03 | | | 0.05 | | | | | | | | |

### Evaluation

The following evaluations were performed on the (meth)acrylic resins and resin compositions for sintering obtained in the examples and comparative examples. Tables 5 and 6 show the results. No evaluations were performed for Comparative Example 2. In Comparative Example 2, since PVA which is a water-soluble surfactant was used, micelles of monomers became big in the reaction system, so that addition of a small amount of polymerization initiator fails to distribute the polymerization initiator to the micelles sufficiently. The monomers therefore could not sufficiently grow to polymers and no (meth)acrylic resin was obtained.

(1) Z average particle size and CV value of particle size The aqueous solutions containing the (meth)acrylic resins obtained by the polymerization in the examples and comparative examples were each supplied to a Zetasizer for measurement of the particle size. The CV value of particle size was calculated using the following expression. CV value (%) = standard deviation ÷ average particle size × 100

(2) Average molecular weight The weight average molecular weight (Mw) and the number average molecular weight (Mn) in terms of polystyrene of the obtained (meth)acrylic resin were measured by gel permeation chromatography using a column LF-804 (available from Shoko Science Co., Ltd.).

(3) Glass transition temperature (Tg) The glass transition temperature (Tg) of the obtained (meth)acrylic resin was measured using a differential scanning calorimeter (DSC). Specifically, the evaluation was performed by heating the (meth)acrylic resin from normal temperature to 150° C. at a rate of temperature rise of 5° C./min in nitrogen atmosphere at a flow rate of 50 mL/min.

(4) Amount of water-soluble surfactant The amount of the water-soluble surfactant in the obtained resin composition for sintering was calculated based on the amount of decomposition gas at 400° C. to 600° C. derived from combustion of the water-soluble surfactant and the amount of decomposition gas at 200° C. to 300° C. derived from decomposition of the (meth)acrylic resin, using a thermogravimetry mass spectrometer (TG-MS device, available from Netzsch).

(5) Tensile test The obtained resin composition for sintering was dissolved in a butyl acetate solution to prepare a resin solution. The resin solution was applied to a release-treated PET film with an applicator, and dried in a fan oven at 100° C. for 10 minutes to prepare a resin sheet having a thickness of 20 µm. Graph paper was used as a cover film. A strip-shaped specimen having a width of 1 cm was prepared with scissors.

The obtained specimen was subjected to a tensile test under the conditions of 23° C. and 50 RH using an autograph AG-IS (available from Shimadzu Corporation) at an inter-chuck distance of 3 cm and a pulling speed of 10 mm/min. The stress-strain chatacteristics (presence or absence of yield stress, measurement of maximum stress and elongation at break) were determined.

(6) Sinterability (6-1) Preparation of conductive paste Each of the resin composition for sintering obtained in the examples and comparative examples was dissolved in a terpineol solvent to a resin solid content of 11% by weight to give a resin composition solution. To 44 parts by weight of the obtained resin composition solution were added 1 part by weight of oleic acid as a dispersant and 55 parts by weight of nickel powder (“NFP201”, available from JFE Mineral Co., Ltd.) as conductive fine particles. The components were mixed with a triple roll mill to give a conductive paste.

(6-2) Preparation of ceramic green sheet Each of the resin compositions for sintering obtained in the examples and comparative examples, inorganic fine particles, a plasticizer, and an organic solvent were added according to the formulation in Table 3 or 4, and mixed with a ball mill to give an inorganic fine particle-dispersed slurry composition.

The obtained inorganic fine particle-dispersed slurry composition was applied to a release-treated polyester film to a dry thickness of 1 µm. The applied slurry was dried at room temperature for one hour, followed by drying at 80° C. for three hours and then at 120° C. for two hours with a hot air dryer. Thus, a ceramic green sheet was prepared.

Barium titanate (“BT-02”, available from Sakai Chemical Industry Co., Ltd., average particle size: 0.2 µm) was used as the inorganic fine particles and butyl acetate was used as the organic solvent.

TABLE 3

Inorganic fine particle-dispersed slurry composition

| | Resin composition for sintering | | Plasticizer | | Organic solvent (parts by weight) | Inorganic fine particles (parts by weight) |
|---|---|---|---|---|---|---|
| | (Meth)acrylic resin (parts by weight) | Water-soluble surfactant (parts by weight) | Type | Amount (parts by weight) | | |
| Example 1 | 10 | 0.001 | Triethyl acetylcitrate | 1.2 | 53.8 | 35 |
| Example 2 | 10 | 0 | Triethyl acetylcitrate | 1.2 | 53.8 | 35 |
| Example 3 | 10 | 0 | Triethyl acetylcitrate | 1.2 | 53.8 | 35 |
| Example 4 | 10 | 0 | Triethyl acetylcitrate | 1.2 | 53.8 | 35 |
| Example 5 | 10 | 0 | Monomethyl adipate | 1.2 | 53.8 | 35 |
| Example 6 | 10 | 0.001 | Monomethyl adipate | 1.2 | 53.8 | 35 |
| Example 7 | 10 | 0.002 | Monomethyl adipate | 1.2 | 53.8 | 35 |
| Example 8 | 10 | 0.001 | Tripropionin | 1.2 | 53.8 | 35 |
| Example 9 | 10 | 0.001 | Diethyl acetylsuccinate | 1.2 | 53.8 | 35 |
| Example 10 | 10 | 0.001 | Triacetin | 1.2 | 53.8 | 35 |
| Example 11 | 10 | 0.001 | Pentaerythritol tetraacetate | 1.2 | 53.8 | 35 |
| Example 12 | 10 | 0.001 | Trimethyl acetylcitrate | 1.2 | 53.8 | 35 |
| Example 13 | 10 | 0.001 | Pentaerythritol tetraacetate | 1.2 | 53.8 | 35 |
| Example 14 | 10 | 0.001 | Dimethyl methoxymalonate | 1.2 | 53.8 | 35 |

TABLE 4

Inorganic fine particle-dispersed slurry composition

| | Resin composition for sintering | | Plasticizer | | Organic solvent (parts by weight) | Inorganic fine particles (parts by weight) |
|---|---|---|---|---|---|---|
| | (Meth)acrylic resin (parts by weight) | Water-soluble surfactant (parts by weight) | Type | Amount (parts by weight) | | |
| Comparative Example 1 | 10 | 0.008 | Di(butoxyethyl) adipate | 1.2 | 53.8 | 35 |
| Comparative Example 2 | - | | | | | |
| Comparative Example 3 | 10 | 0.003 | Di(butoxyethyl) adipate | 1.2 | 53.8 | 35 |
| Comparative Example 4 | 10 | 0.003 | Di(butoxyethyl) adipate | 1.2 | 53.8 | 35 |
| Comparative Example 5 | 10 | 0.1 | Di(butoxyethyl) adipate | 1.2 | 53.8 | 35 |
| Comparative Example 6 | 10 | 0.001 | Di(butoxyethyl) adipate | 1.2 | 53.8 | 35 |
| Comparative Example 7 | 10 | 0.001 | Di(butoxyethyl) adipate | 1.2 | 53.8 | 35 |
| Comparative Example 8 | 10 | 0.001 | Di(butoxyethyl) adipate | 1.2 | 53.8 | 35 |
| Comparative Example 9 | 10 | 0.003 | Di(butoxyethyl) adipate | 1.2 | 53.8 | 35 |

### 3) Preparation of Ceramic Fired Body

The obtained conductive paste was applied to one surface of the obtained ceramic green sheet to a dry thickness of 1.5 µm by a screen printing method. The paste was dried to form a conductive layer, whereby a ceramic green sheet with a conductive layer was obtained. The obtained ceramic green sheet with a conductive layer was cut to a 5-cm square. One hundred 5-cm square ceramic green sheets were stacked together and pressure-bonded with heat for 10 minutes under the conditions of a temperature of 70° C. and a pressure of 150 kg/cm², whereby a laminate was obtained.

The obtained laminate was heated in a nitrogen atmosphere to 400° C. at a rate of temperature rise of 3° C./min, and held at the temperature for five hours, then heated to 1350° C. at a rate of temperature rise of 5° C./min, and held at the temperature for 10 hours. Thus, a ceramic fired body was prepared.

### 4) Evaluation on Sinterability

The obtained ceramic fired body was cut and the cross section was observed with an electron microscope. Evaluation was made based on the following criteria.

In the case of using the resin composition for sintering of Comparative Example 1 or 4, no laminate was obtained, failing to prepare a ceramic fired body.

◯ (Good): The ceramic fired body had no voids, cracks, or peelings, and the layers were bonded to each other.

× (Poor): The ceramic fired body had voids, cracks, or peelings. The ceramic fired body could not be obtained.

### Solution Haze

The obtained resin composition for sintering was dissolved in butyl acetate to prepare a solution having a resin concentration of 10% by weight. The haze of the solution was measured using a haze meter (“HM-150”, available from Murakami Color Research Laboratory).

### Surface Roughness

The center line average roughness (Ra) of the surface of the ceramic green sheet obtained in “(6) Sinterability” was measured using a stylus-type roughness meter (“SURFCOM 1400D”, available from Tokyo Seimitsu Co., Ltd.) by a method in conformity with JIS B 0601, and evaluated based on the following criteria. The case where Ra was 0.05 µm or less was rated oo (Excellent). The case where Ra was 0.1 µm or less was rated o (Good). The case where Ra was more than 0.1 µm was rated × (Poor).

◯ ◯ (Excellent): Ra was 0.05 µm or less.

◯ (Good): Ra was more than 0.05 µm but not more than 0.1 µm. × (Poor): Ra was more than 0.1 µm.

TABLE 5

| | (Meth)acrylic resin | | | | | | Tensile test | | | Sinterability | Solution haze | Surface roughness (Ra) |
|---|---|---|---|---|---|---|---|---|---|---|---|---|
| | End structure | Resin particle size | | Average molecular weight | | Glass transition temperature (Tg) | | | | | | |
| | | Z average particle size (nm) | CV value (%) | Mw (million) | Mw//Mn | (°C) | Yield stress | Maximum stress (N/mm²) | Elongation at break (%) | Judgement | Measurement | |
| Example 1 | Sulfone group (—SO₂—OH) | 500 | 6 | 5 | 2.0 | 56.6 | Present | 47 | 290 | ◦ | 5 | ◦ |
| Example 2 | Sulfone group (—SO₂—OH) | 400 | 6 | 3 | 1.9 | 40.0 | Present | 36 | 210 | ◦ | 4 | ◦◦ |
| Example 3 | Imidazoline group | 400 | 6 | 3 | 1.8 | 58.7 | Present | 43 | 190 | ◦ | 4 | ◦◦ |
| Example 4 | Sulfone group (—SO₂—OH) | 200 | 3 | 1 | 1.9 | 45.5 | Present | 33 | 240 | ◦ | 4 | ◦◦ |
| Example 5 | Amino group (—C(NH)—NH₂) | 300 | 5 | 2 | 2.0 | 46.0 | Present | 38 | 110 | ◦ | 4 | ◦◦ |
| Example 6 | Carboxy group (—C(NH)—NHCH₂CH₂—COOH) | 500 | 8 | 6 | 1.8 | 42.2 | Present | 36 | 320 | ◦ | 7 | ◦ |
| Example 7 | Hydroxy group (—C(O)—NHCH₂CH₂—OH) | 600 | 10 | 7 | 2.0 | 40.8 | Present | 41 | 380 | ◦ | 9 | ◦ |
| Example 8 | Sulfone group (—SO₂—OH) | 400 | 8 | 3 | 1.9 | 35 | Absent | 30 | 200 | ◦ | 4 | ◦ |
| Example 9 | Sulfone group (—SO₂—OH) | 400 | 8 | 3 | 1.9 | 65 | Present | 50 | 100 | ◦ | 5 | ◦ |
| Example 10 | Sulfone group (—SO₂—OH) | 400 | 8 | 8 | 2.1 | 55 | Present | 48 | 300 | ◦ | 11 | × |
| Example 11 | Sulfone group (—SO₂—OH) | 700 | 10 | 3 | 2.1 | 55 | Present | 44 | 200 | ◦ | 6 | ◦ |
| Example 12 | Aromatic sulfonyl group (—SO₂—C₆H₅) | 300 | 20 | 1 | 2.1 | 55 | Present | 38 | 100 | ◦ | 4 | ◦ |
| Example 13 | Sulfine group (—SO—O—C₂H₅) | 300 | 6 | 1 | 1.9 | 55 | Present | 42 | 150 | ◦ | 4 | ◦ |
| Example 14 | Amide group(—CH₂CH₂—C(O)—NH₂) | 300 | 6 | 1 | 1.9 | 55 | Present | 42 | 150 | ◦ | 4 | ◦ |

TABLE 6

| | (Meth)acrylic resin | | | | | | Tensile test | | | Sinterability | Solution haze | Surface roughness (Ra) |
|---|---|---|---|---|---|---|---|---|---|---|---|---|
| | End structure | Resin particle size | | Average molecular weight | | Glass transition temperature (Tg) | | | | | | |
| | | Z average particle size (nm) | CV value (%) | Mw (million) | Mw//Mn | (°C) | Yield stress | Maximum stress (N/mm²) | Elongation at break (%) | Judgement | Measurement | |
| Comparative Example 1 | Sulfone group (—SO₂—OH) | 100 | 30 | 0.5 | 2.0 | 89.4 | Absent | No yield value | 10 | × | 15 | × |
| Comparative Example 2 | - | | | | | | - | | | - | - | - |
| Comparative Example 3 | Sulfone group (—SO₂—OH) | 800 | 20 | 3 | 3.0 | 29.9 | Absent | 28 | 200 | × | 10 | ◦ |
| Comparative Example 4 | Sulfone group (—SO₂—OH) | 1200 | 30 | 1 | 2.5 | 72.4 | Absent | No yield value | 18.0 | × | 10 | ◦ |
| Comparative Example5 | Sulfone group (—SO₂—OH) | 2000 | 40 | 1 | 2.5 | 52.4 | Absent | 35 | 20.0 | × | 18 | × |
| Comparative Example 6 | Isopropyl group | 2000 | 50 | 1 | 2.0 | 56 | Present | 45 | 80 | × | 4 | ◦ |
| Comparative Example 7 | Octyl group | 2000 | 40 | 1 | 2.0 | 56 | Present | 45 | 80 | × | 4 | ◦ |
| Comparative Example 8 | Sulfone group (—SO₂—OH) | 100 | 6 | 0.5 | 2.0 | 56 | Present | 42 | 50 | × | 3 | ◦ |
| Comparative Example 9 | Sulfone group (—SO₂—OH) | 500 | 8 | 5 | 2.0 | 56 | Present | 48 | 200 | × | 13 | × |

Examples 1 to 7 were confirmed to have excellent characteristics in every evaluation item. In contrast, Comparative Examples 1 and 4 were brittle in the sheet tensile test to have only small elongation at break. The ceramic green sheets therefore had poor handleability, failing to provide laminates. In Comparative Example 3, the obtained (meth)acrylic resin had a low glass transition temperature (Tg), so that the resulting ceramic green sheet had no resilience and had uneven thickness, resulting in peeling between layers of the ceramic fired body. In Comparative Example 5, voids due to decomposition gas of residual carbon were observed at the center part of the ceramic fired body.

### INDUSTRIAL APPLICABILITY

The present invention can provide a resin composition for sintering which has excellent decomposability at low temperature, can provide a molded article having high strength, and enables an increase in the number of layers and thinning so as to enable production of a ceramic laminate having excellent properties. The present invention can provide an inorganic fine particle-dispersed slurry composition containing the resin composition for sintering, and an inorganic fine particle-dispersed sheet formed using the resin composition for sintering or the inorganic fine particle-dispersed slurry composition.

1. A resin composition for sintering, comprising a binder resin,
the binder resin comprising a (meth)acrylic resin (A),
the (meth)acrylic resin (A) having at least one selected from the group consisting of a sulfone group, an alkyl sulfonyl group, an aromatic sulfonyl group, a sulfine group, an imidazoline group, a carboxy group, an amide group, an amino group, and a hydroxy group at at least one molecular end of a main chain and having a weight average molecular weight (Mw) of 1,000,000 or more,
an amount of a water-soluble surfactant in the resin composition for sintering being 0 parts by weight or more and 0.02 parts by weight or less per 100 parts by weight of the binder resin.

2. The resin composition for sintering according to claim 1,
wherein the (meth)acrylic resin (A) has a glass transition temperature (Tg) of 40° C. or higher.

3. The resin composition for sintering according to claim 1, wherein the (meth)acrylic resin (A) has a CV value of particle size of 10% or lower.

4. The resin composition for sintering according to claim 1,
wherein the (meth)acrylic resin (A) comprises 40% by weight or more of a segment derived from isobutyl methacrylate.

5. The resin composition for sintering according to claim 1,
wherein the (meth)acrylic resin (A) comprises a segment derived from at least one selected from the group consisting of methyl methacrylate, n-butyl methacrylate, and ethyl methacrylate.

6. The resin composition for sintering according to claim 1,
wherein the (meth)acrylic resin (A) has a ratio (Mw/Mn) of weight average molecular weight (Mw) to number average molecular weight (Mn) of 2.0 or less.

7. The resin composition for sintering according claim 1,
wherein the (meth)acrylic resin (A) molded into a sheet form having a thickness of 20 µm shows yield stress and has a maximum stress of 30 N/mm² or more and an elongation at break of 50% or higher.

8. The resin composition for sintering according to claim 1, further comprising an organic solvent having a boiling point of 70° C. or higher.

9. The resin composition for sintering according to claim 8,
wherein the resin composition adjusted to contain 10% by weight of the binder resin has a haze of lower than 10%.

10. An inorganic fine particle-dispersed slurry composition comprising: the resin composition for sintering according to claim 1; and inorganic fine particles.

11. An inorganic fine particle-dispersed sheet formed using the resin composition for sintering according to claim 1 or the inorganic fine particle-dispersed slurry composition according to claim 10.
